(19) United States
(12) Patent Application Publication
(10) Pub. No.: US 2010/0092239 A1
(43) Pub. Date: Apr. 15, 2010

(54) FIXING ELEMENT AND APPARATUS FOR ACCOMMODATING A FIXING ELEMENT

(76) Inventors: Günther Deinhardt, Amberg (DE); Roland Fürholzer, Amberg (DE); Ulrich Ringer, Amberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/577,387

(22) Filed: Oct. 12, 2009

(30) Foreign Application Priority Data
Oct. 13, 2008 (EP) 08017922.9

(51) Int. Cl. F16B 21/00

(52) U.S. Cl. 403/321

(57) ABSTRACT

A fixing element including a bolt with a first region with a first cross-section and a second region with a second cross-section is provided. The fixing element further includes a clamping wing with a first bearing surface, the clamping wing being arranged in the second region, and a transition point between the first and the second region, which is configured at least partially as a second bearing surface. The first and the second bearing surfaces are arranged opposite one another such that a first material part and a second material part are mounted between the first bearing surface and the second bearing surface by executing a rotary motion. The second bearing surface includes a first sliding part and a second sliding part, wherein, starting from an insertion position, a tension force increasing in the axial direction until a locking position is reached as a result of the rotary motion.

### CROSS REFERENCE TO RELATED APPLICATIONS

This application claims priority of European Patent Office Application No. 08017922.9 EP filed Oct. 13, 2008, which is incorporated by reference herein in its entirety.

### FIELD OF INVENTION

The invention relates to a fixing element comprising a bolt with a first region having a first cross-section and a second region having a second cross-section, a clamping wing with a first bearing surface, with the clamping wing being arranged in the second region, a transition between the first and the second region, which is embodied at least partially as a second bearing surface, with the first and the second bearing surface being arranged opposite one another so that a first material part and a second material part can be mounted between the first bearing surface and the second bearing surface by executing a rotary motion.

The invention also relates to an apparatus in a first material part for accommodating a fixing element including a cylindrical socket with an insertion opening and an outlet opening, with it being possible to insert the fixing element into the insertion opening and said fixing element partially protruding beyond the outlet opening in order to include a second material part.

### BACKGROUND OF INVENTION

For the assembly of electronics systems for instance, according to the application, a more or less large number of modules are suspended adjacent to one another on a profile rail fastened to a switching cabinet wall for instance. In such cases an upper edge of the module is inserted first and the lower edge engages with the profile rail by means of a pivoting movement and the module is thus brought into its final position. When positioning the modules, said modules are preferably in contact with one another by way of a rear wall bus and/or by way of connecting terminals. A secure fixing possibility is needed in order to guarantee all contacts, even under industrial conditions for instance, such as particular vibrations, shock, dust, heat, cold etc. Hooking a module over a profile rail by means of a snap-on hook is disadvantageous in that the snap-on hook, in order to guarantee its ability to snap on behind the rail, has to have a play between a detent and the profile rail. If this play does not exist, the snap-on mechanism does not work. This play nevertheless results in an inadequate contact force prevailing between the module and the profile rail in the case of a correctly dimensioned snap-on hook in the locked state, said contact force not being well-suited for use under industrial conditions.

A solution of the previously cited module which can be engaged in a profile rail in which a screw connection is used rather than the snap-on hook, is also disadvantageous since a number of complete turns are needed in order to tighten the screw and the assembler requires more time for the assembly.

EP 0 943 824 B1 discloses a mechanical connecting element as a quick release fastener with the features of the fixing element cited in the introduction. This connecting element is disadvantageous in that a travel resulting from the rotary motion is not sufficient to generate a required contact pressure.

### SUMMARY OF INVENTION

An object of the invention is to provide a fixing element which generates greater travel in the case of a rotary motion of the fixing element and thus a better tolerance compensation.

The object is achieved in that the second bearing surface has at least a first sliding part and a second sliding part, with, starting from an insertion position, a tension force increasing in the axial direction until a locking position is reached as a result of the rotary motion. Since the clamping wing with a first bearing surface in accordance with the prior art with relatively small surfaces on the clamping wing only allows a small travel, it is advantageous for the fixing element to have additional sliding parts on its second bearing surface, with the sliding parts being embodied as ramps extending around the bolts. As the bearing surface of the fixing element is generally dimensioned to be larger than the clamping wing, a greater travel and thus a considerably greater clamp travel can be generated by means of an embodiment of the sliding parts during a rotary motion of the fixing element. The second bearing surface, which was previously a flat, planar surface, and/or as described in EP 0 943 824 B1, which is provided on one side with securing edges shaped like a blade, is thus embodied with additional sliding parts so as to increase the contact path in accordance with the invention.

In one advantageous embodiment, the clamping wing has a first wing part with a first bevel and a second wing part with a second bevel, with the first and the second bevel forming the first bearing surface. During the rotary motion, the bevels of the clamping wing become wedged in a cavity of the second material part which is provided herefor and, as a result of their bevels, likewise provide for a proportionate travel and/or for the generation of a proportionate tension force. If the fixing element is used for instance as a quick release fastener for a module with an apparatus provided correspondingly herefor, it is also advantageous for the clamping wing to be two parts, in other words a first wing part and a second wing part, since this “double wing” prevents a lateral displacement of the module during the locking process as a result of the one-sided friction of the clamping wing on a profile rail wall for instance. This is advantageous in that a “play-free” position results in the assembled state, i.e. the tolerances between the bearing surfaces are minimized.

It is also advantageous for the clamping wing to be configured so as to penetrate into an opening in the second material part. The clamping wing is configured here such that it can penetrate through an opening, for instance in the profile rails already mentioned and is twisted into a position whereby the clamping wing is prevented from slipping out.

In a further optimized configuration, the first sliding part and/or the second sliding part is configured for the positive connection to a first opposing surface and/or to a second opposing surface of the second material part. An angle of the sliding parts is selected in the case of a material pairing used in each instance such that a self-locking occurs. In other words, the locking device does not open by itself, since the frictional forces on the pressed surfaces are greater than the resulting forces, which would move the locking device to open as a result of the clamping.

Since fixing elements of this type could possibly fall out of their apparatuses during assembly, by way of a head for instance, it is advantageous for the first region to be configured with a groove for accommodating a latching lug. This latching lug, which engages in the groove, nevertheless allows for rotation of the fixing element, but prevents the fixing element from falling out of the component to be fixed in each instance. The fixing element is thus captive with regard to the respective material or component.

A head region of the first region is preferably configured to accommodate a tool for exerting the rotary motion. A hexagon or a slot for accommodating a tool is arranged on the head region for instance.

As the rotary motion of such a fixing element is generally restricted to a quarter rotation, it is advantageous for a stop for restricting the rotary motion to be arranged at the transition point. Rotation beyond a maximum torque to be generated is thus prevented.

The apparatus cited in the introduction likewise achieves the object cited in the introduction since the apparatus and the fixing element relate to a common inventive idea.

The object is thus achieved with the apparatus in that at least one first opposing surface and/or a second opposing surface are arranged within the socket as a opposing bearing for the positive connection of a first sliding part and/or a second sliding part, with the opposing surfaces having a ramp-shaped characteristic. The combination of ramp-shaped sliding parts on the fixing element and ramp-shaped opposing surfaces in the apparatus enable travel to be maximized despite the small design of the fixing element by using an amplifying travel if a ramp-shaped sliding part rests on a ramp-shaped opposing surface and in the case of a rotary motion.

To realize the already mentioned captive facility, it is advantageous for a flexible bar to be formed in a socket wall by means of two longitudinal sections in the apparatus which is in parallel with a symmetry axis of the socket and for the bar to have a latching lug. This latching lug can engage in the previously mentioned groove of the fixing element and can provide for the fixing element to be held captive by the apparatus.

One particularly advantageous embodiment is if the socket is arranged in or on a housing of an automation component in order to fix this automation component to a profile rail.

### BRIEF DESCRIPTION OF THE DRAWINGS

Further advantageous embodiments and possible models are explained with reference to the drawing, in which:

FIG. 1 to FIG. 6 show a fixing element in four lateral views, a bottom view and a top view,

FIG. 7 shows a fixing element with an associated apparatus arranged on a module for fixing to a profile rail in a perspective view and

FIG. 8 shows the apparatus for accommodating the fixing element in a perspective view.

### DETAILED DESCRIPTION OF INVENTION

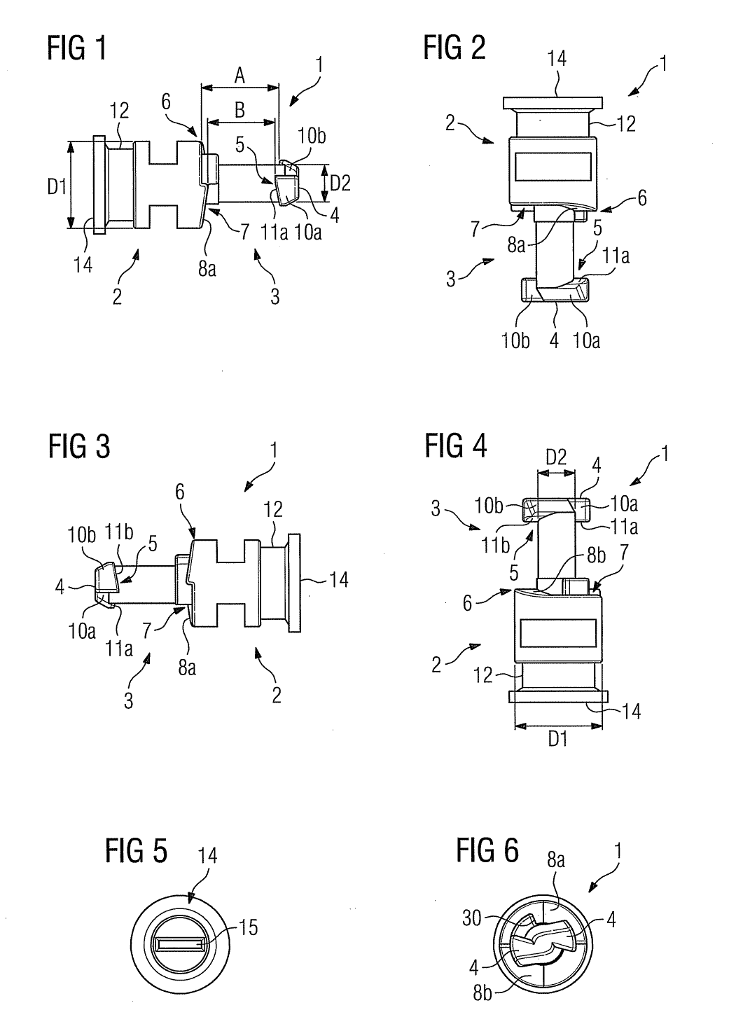

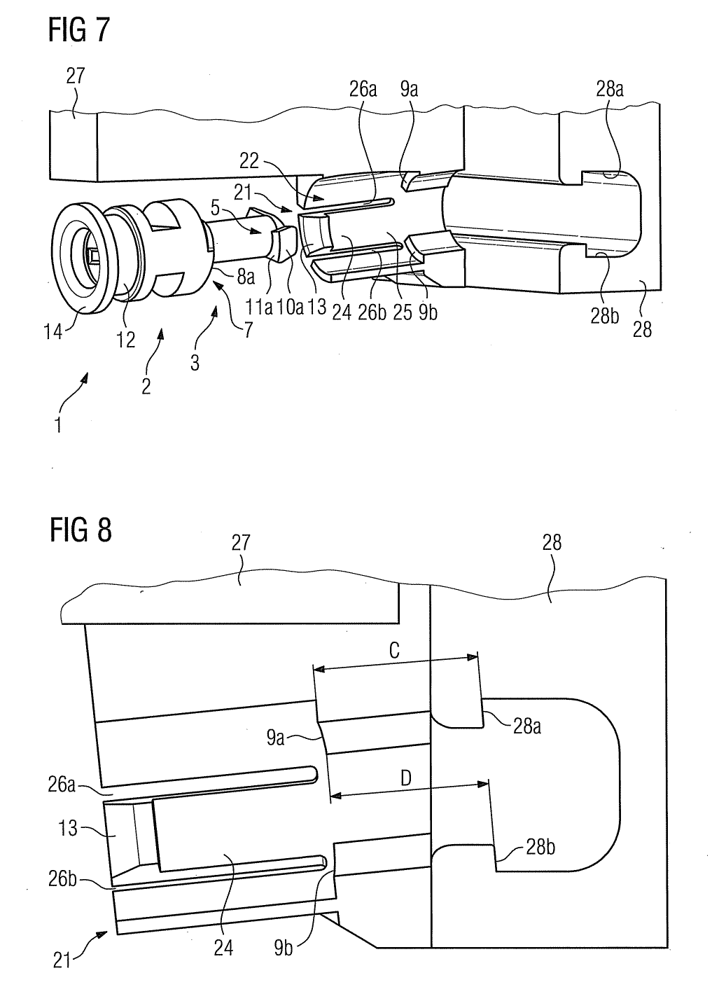

According to FIGS. 1 to 6, a fixing element 1 is shown in six views, with FIGS. 1 to 4 each reproducing a side view of the fixing element 1 which is rotated about 90° respectively and FIG. 5 showing a top view onto a head region 14 of the fixing element 1 and FIG. 6 showing a bottom view onto a clamping wing 4 of the fixing element 1. Based on FIG. 1, the fixing element 1 is formed by a bolt with a first region 2 comprising a first cross-section and a second region 3 comprising a second cross-section. The first region 2 essentially has a diameter of D1 here and the second region 3 essentially has a diameter of S2 here, with the diameter D1 being greater than the diameter D2. The diameter D2 jumps at a transition point 6 to the diameter D2 of the bolt. A second bearing surface 7 forms here on the transition point 6. The second bearing surface 7 has a first sliding part 8a and a second sliding part 8b, with, starting from an insertion position of the fixing element 1, a clamping force being achieved in the axial direction until reaching a locking position by means of a rotary motion. This presumes that a clamping wing 4 has a first wing part 10a with a first bevel 11a and a second wing part 10b with a second bevel 11b. The first and the second bevels 11a and 11b here form a first bearing surface 6. This bearing surface is used here to clamp a housing 27 (see FIG. 7 and FIG. 8) to a profile rail 28.

In FIG. 1, the first sliding part 8a faces the first bevel 11a. It forms a minimal distance B between the first sliding part 8a and the first bevel 11a. Similarly, a maximum distance A fowls between the second sliding part 8b and the second bevel 11b, which cannot be seen as a result of the illustration in FIG. 1 (see here FIG. 4). A difference between the distances A-B here describes a first travel, which the fixing element executes during a rotary motion.

The first bevel 11a and the second bevel 11b also generate an additional travel as a result of the anchoring in the profile rail 28 shown in FIG. 7. A stop 30 is arranged at the transition point 6 of the second bevel 7. This stop is used to restrict a rotary motion.

In accordance with FIG. 5, the top view onto the head region 14 is shown, a slot 15 for receiving a screwdriver is arranged within the head region 14.

FIG. 6 shows a bottom view of the fixing element 1 on the clamping wing 4, with the first sliding part 8a and the second sliding part 8b each being arranged diametrically opposite to one another as quarter segments of the cylinder surface in each instance.

FIG. 7 shows a perspective illustration of the fixing element 1 and a housing 27 for fixing to a profile rail 28. A socket 21 for accommodating the fixing element 1 is arranged on the housing 27. The socket 21 has a first longitudinal section 26a and a second longitudinal section 26a in a socket wall 24. A bar 24 is formed through the first longitudinal section 26a and the second longitudinal section 26b.

As viewed based on an insertion opening 22, the bar 24 has a latching lug 13 at the start. This latching lug 13 is embodied so as to engage in the groove 12 of the fixing element 1 and thus renders the fixing element 1, in the inserted state, captive in respect of the socket 21. If the fixing element 1 is inserted in the socket 21 and is positioned in an insertion position, the first sliding part 8a and the second sliding part 8b are placed on a first opposing surface 9a and a second opposing surface 9b by means of a rotary motion, said opposing surfaces being arranged inside the socket 21 on the socket wall 9a. The first opposing surface 9a and/or the second opposing surface 9b form a opposing bearing for the first sliding part 9a and/or the second sliding part 9b for the positive connection of the first and second sliding part 8a, 8b. The opposing surfaces 9a, 9b here are in the shape of a ramp.

Starting from the insertion position, the clamping wing 4 with its first bevel 11a and its second bevel 11b protrudes into a profile rail groove of the profile rail 28. With the said rotation in the clockwise direction, the clamping wing 4 thus also turns so that it comes to rest in its end position with is first bevel 11a on a second holding surface 28b and with its second bevel 11b on a first holding surface 28 inside the profile rail groove. As a result of the rotary motion and the sliding surfaces 8a, 8b which are arranged opposite one another in respect of the opposing surfaces 9a, 9b, a first travel is produced with a travel from A-B, as shown in FIG. 1. This travel allows for the creation of an axial tension force, which presses the profile rail 28 against the housing 27 and vice versa, the housing 28 presses against the socket and the opposing surface 9 by means of force.

To increase the total travel which is made up of the first and second travel, with the total travel being made up as follows:

Total-travel=Delta 1+Delta 2=(A−B)+(C−D),

the first and second opposing surfaces 9a, 9b are arranged such that a further maximum distance C and a further minimum distance D result for the formation of the ramp-shaped surface, see FIG. 8.

1.-10. (canceled)

11. A fixing element, comprising:
a bolt with a first region including a first cross-section and a second region including a second cross-section;
a clamping wing with a first bearing surface, the bearing surface being arranged in the second region; and
a transition point between the first and the second region, the transition point being embodied at least partially as a second bearing surface,
wherein the first and the second bearing surfaces are arranged opposite to one another such that a first material part and a second material part are mounted between the first bearing surface and the second bearing surface by executing a rotary motion,
wherein the second bearing surface includes a first sliding part and a second sliding part, and wherein, starting from an insertion position, a tension force increases in an axial direction until a locking position is reached as a result of the rotary motion.

12. The fixing element as claimed in claim 11, wherein the clamping wing includes a first wing part with a first bevel and a second wing part with a second bevel, the first and the second bevel forming the first bearing surface.

13. The fixing element as claimed in claim 11, wherein the clamping wing is configured to penetrate into an opening of the second material part.

14. The fixing element as claimed in claim 12, wherein the clamping wing is configured to penetrate into an opening of the second material part.

15. The fixing element as claimed in claims 11, wherein the first sliding part and the second sliding part are configured for a positive connection on a first opposing surface and on a second opposing surface of the second material part.

16. The fixing element as claimed in claim 11, wherein the first sliding part is configured for a positive connection on a first opposing surface of the second material part.

17. The fixing element as claimed in claim 11, wherein the second sliding part is configured for a positive connection on a second opposing surface of the second material part.

18. The fixing element as claimed in claim 11, wherein the first region is configured with a groove for accommodating a latching lug.

19. The fixing element as claimed in claim 12, wherein the first region is configured with a groove for accommodating a latching hug.

20. The fixing element as claimed in claim 11, wherein a head region of the first region is configured to accommodate a tool to execute the rotary motion.

21. The fixing element as claimed in claim 12, wherein a head region of the first region is configured to accommodate a tool to execute the rotary motion.

22. The fixing element as claimed in claim 11, wherein a stop for restricting the rotary motion is arranged on the transition point.

23. The fixing element as claimed in claim 12, wherein a stop for restricting the rotary motion is arranged on the transition point.

24. An apparatus in a first material part for accommodating a fixing element, comprising:
a cylindrical socket comprising an insertion opening and an outlet opening, the fixing element being inserted into the insertion opening and partially protruding beyond the outlet opening in order to use a second material part,
wherein a first opposing surface and a second opposing surface are arranged within the socket as opposing bearings for a positive connection of a first sliding part and a second sliding part, the opposing surfaces having the shape of a ramp.

25. The apparatus as claimed in claim 24, wherein a flexible bar is formed in a socket wall of the socket by two longitudinal sections in parallel with a symmetry axis of the socket.

26. The apparatus as claimed in claim 25, wherein the bar includes a latching lug.

27. The apparatus as claimed in claim 24, wherein the socket is arranged inside a housing of an automation component for fixing to a profile rail.

28. The apparatus as claimed in claim 25, wherein the socket is arranged inside a housing of an automation component for fixing to a profile rail.

29. The apparatus as claimed in claim 24, wherein the socket is arranged outside a housing of an automation component for fixing to a profile rail.

30. The apparatus as claimed in claim 25, wherein the socket is arranged outside a housing of an automation component for fixing to a profile rail.
